(19) United States
(12) Patent Application Publication
(10) Pub. No.: US 2005/0118956 A1
(43) Pub. Date: Jun. 2, 2005

(54) Audio enhancement system having a spectral power ratio dependent processor

(76) Inventors: Reinhold Haeb-Umbach, Aachen (DE); Cornelis Pieter Janse, Eindhoven (NL); David Antoine Christian Marie Roovers, Eindhoven (NL)

Correspondence Address: Philips Electronics North America Corporation;Corporate Patent Counsel, PO Box 3001, Briarcliff Manor, NY, 10510, US

(21) Appl. No.: 10/500,758

(22) PCT Filed: Dec. 9, 2002
(86) PCT No.: PCT/IB02/05295

(30) Foreign Application Priority Data
Jan. 9, 2002 (EP) 02075081.6

(51) Int. Cl. H04B 7/01

(52) U.S. Cl. 455/67.11; 455/501

(57) ABSTRACT

An audio enhancement system is described, comprising audio signal inputs for a distorted desired signal and at least a reference signal, and a spectral processor coupled to the microphone array for processing the distorted desired signal by means of the reference signal acting as an estimate for the distortion of the desired signal. The spectral processor is arranged for modifying said processing such that the estimate for the distortion depends on A times the spectral power of the reference signal, where A is the ratio between the time averaged spectral power of the distortion of the distorted desired signal and the time averaged spectral power of the reference signal. The frequency dependency of the ratio A which is included in the distortion estimate, results in an improved audio enhancement system which is better suited for application in situations wherein the relation between the interfering signal and the distortion in the desired signal is not known in advance, such as for example in a car environment.

The present invention relates to an audio enhancement system, comprising audio signal inputs for a distorted desired signal and at least a reference signal, and a spectral processor coupled to the audio signal inputs for processing the distorted desired signal by means of the at least one reference signal acting as an estimate for the distortion of the desired signal.

The present invention also relates to a method for enhancing a distorted desired signal, which signal is spectrally processed, whereby at least one reference signal acts as an estimate for the distortion of the desired signal.

Such an audio enhancement system embodied by an arrangement for suppressing an interfering component, such as distorting noise is known from WO 97/45995. The known system comprises a number of microphones coupled to audio signal inputs. The microphones comprise a primary microphone for a distorted desired signal and one or more reference microphones for receiving the interfering signal. The system also comprises a spectral processor embodied by signal processing arrangement coupled to the microphones. In the signal processing arrangement the interfering signal is spectrally subtracted from the distorted signal to reveal at its output an output signal, which comprises a reduced interfering noise component.

It is a disadvantage of the known audio enhancement system that its interference cancelling capabilities are insufficient in situations wherein the relation between the interfering signal and the distortion in the desired signal is not known in advance, such as for example in a car environment.

Therefore it is an object of the present invention to provide an improved audio enhancement system and associated method having an extended application field.

Thereto the audio enhancement system according to the invention is characterized in that the spectral processor is arranged for modifying said processing such that the estimate for the distortion is a function of A times the spectral power of the at least one reference signal, where A is a ratio between the time averaged spectral power of the distortion of the desired signal and the time averaged spectral power of the at least one reference signal.

Similarly the method according to the invention is characterized in that the spectral processing is performed such that the estimate for the distortion depends on A times the spectral power of the at least one reference signal, where A is the ratio between the time averaged spectral power of the distortion of the distorted desired signal and the time averaged spectral power of the at least one reference signal.

The inventors found that the ratio as defined introduces an advantageous frequency function in the relation between the at least one reference signal and the estimate for the distortion in the distorted desired signal not accounted for in the prior art arrangement. Due to the functional dependency the audio enhancement system is better suited for reliable application in for example a factory or a vehicle, such as a car, airplane and the like, because the ratio term A is capable of describing the estimate for the distortion more accurately, without the need for a priori knowledge about the relation between the interfering signal and the distortion in the desired signal. This improves distortion cancellation, especially in cases where the one or more reference signals comprise distortions such as e.g. noise, echoes, competing speech, reverberation of desired speech and the like. Advantageously the frequency dependent estimate for the distortion can be computed in any scenario where some reference signal(s) is(are) available.

Further advantages are that no explicit estimation of individual distortion components, such as noise floor or echo tail is necessary, while a combination technique with these components can be achieved easily, if required. This is particularly advantageous in cases of distortion for which no good estimation techniques exist, such as for microphone beam forming applications. In addition a tuning of a heuristic well known over subtraction factor is to a great extend no longer necessary in the audio enhancement system according to the invention.

An embodiment of the audio enhancement system according to the invention is characterized in that the estimate for the distortion is at least partly proportional to A times the spectral power of the al least one reference signal.

The proportionality may then be expressed by an over subtraction factor, which may be smaller than, equal to or larger than 1. With the over subtraction factor the amount of distortion suppression can be influenced. This way a trade-off can be made between the amount of distortion suppression and the perceptual quality of the output signal of the processor.

A further elaborated embodiment of the audio enhancement system according to the invention is characterized in that the estimate for the distortion at least partly depends on the signal to noise ratio of the distorted desired signal.

Both in this, as well as in the embodiments mentioned above the parts wherein the dependencies occur may concern for example low or high frequency parts of the spectra at hand.

A further embodiment of the audio enhancement system according to the invention is characterized in that the respective spectral powers are defined by some positive function of the spectral power concerned, such as the spectral magnitude, the squared spectral magnitude, the power spectral density or the Mel-scale smoothed spectral density.

In general the estimate of the distortion of the desired signal may be expressed by some positive function, for example in terms of signal power or signal energy, which in turn are defined by one of the above spectral units.

A still further embodiment of the audio enhancement system according to the invention is, characterized in that the ratio A is calculated based on data acquired during absence of the desired signal.

During absence of the desired signal, which generally is the speech signal, the distorted desired speech signal represents the distortion in the distorted desired speech signal. Therefore the ratio A can be measured in absence of the desired speech as the ratio between the time averaged spectral power of the distorted desired speech signal and the time averaged power of the at least one reference signal. Generally the value of A will be used al least during some time after the reappearance of the desired speech signal.

A further exemplified simple embodiment of the audio enhancement system according to the invention is characterized in that the speech enhancement system comprises a speech activity detector, which is coupled to the spectral processor.

Another embodiment of the audio enhancement system according to the invention is characterized in that the audio enhancement system comprises adaptive microphone filter means coupled to the spectral processor.

These microphone adaptive filter means may be combined with the audio enhancement system in order to provide adequate spectral processing for cancelling distortions.

Still another embodiment of the audio enhancement system according to the invention is characterized in that the audio enhancement system comprises one or more loudspeakers and echo cancelling filter means coupled between the at least one loudspeaker and the spectral processor.

Advantageously this embodiment combines acoustic echo cancellation, loudspeaker signal processing and distortion cancellation, in addition to possible microphone signal processing.

At present the audio enhancement system and method according to the invention will be elucidated further together with their additional advantages, while reference is being made to the appended drawing, wherein similar components are being referred to by means of the same reference numerals.

In the drawings:

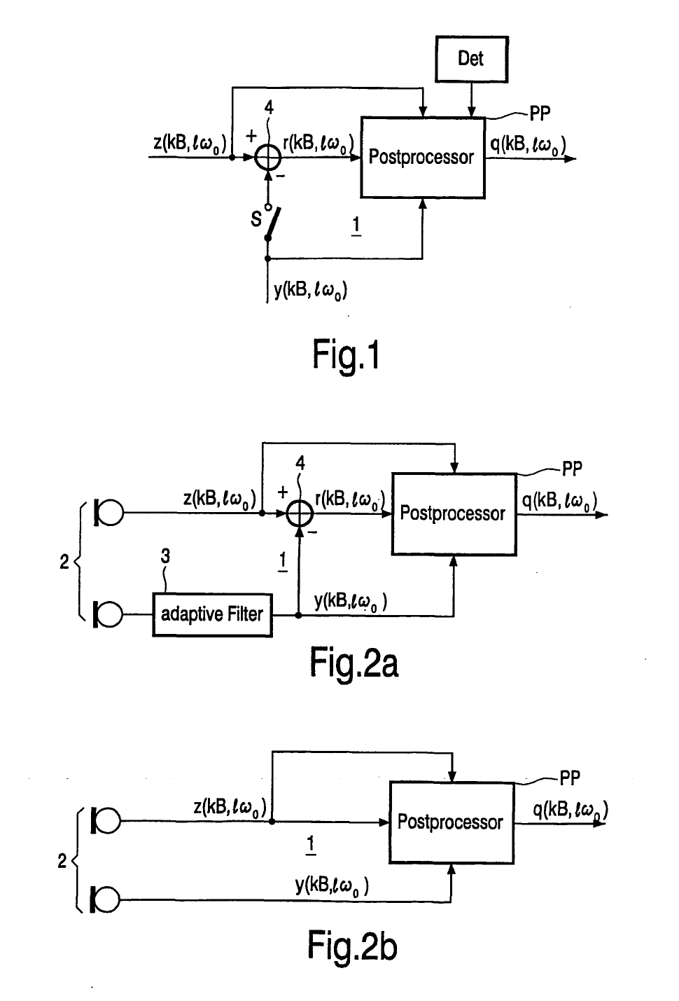

FIG. 1 shows a basic diagram of the audio enhancement system according to the invention;

FIGS. 2a and 2b show embodiments of the audio enhancement system of FIG. 1 with and without microphone adaptive filter means respectively;

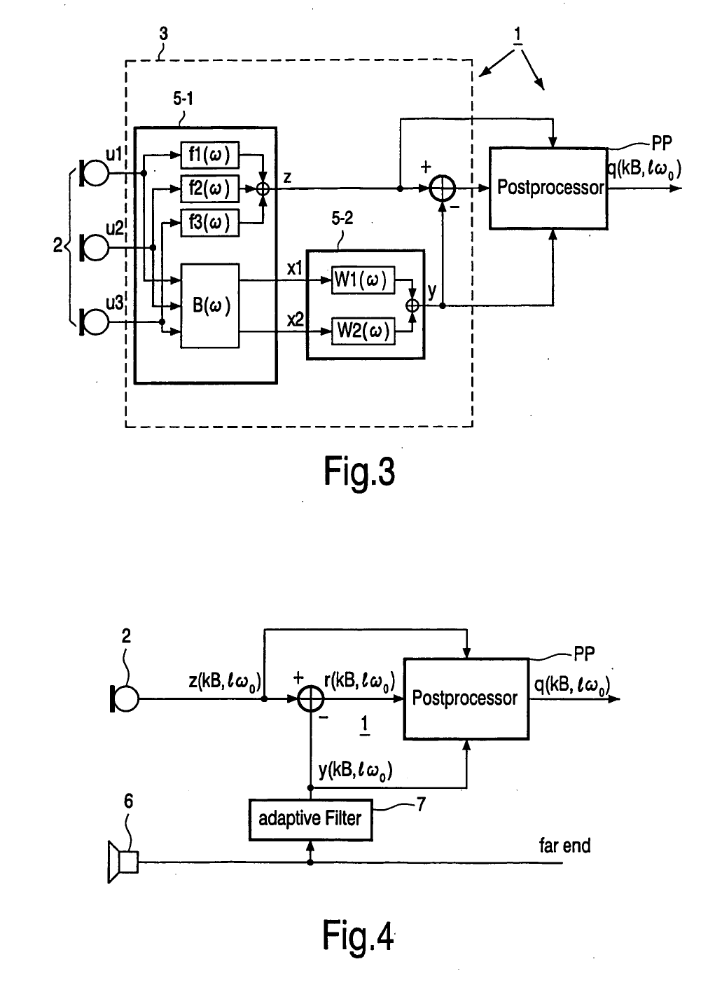

FIG. 3 shows a further embodiment of an audio enhancement system according to the invention having a microphone beamformer;

FIG. 4 shows a still further embodiment of the audio enhancement system according to the invention having an echo canceller; and

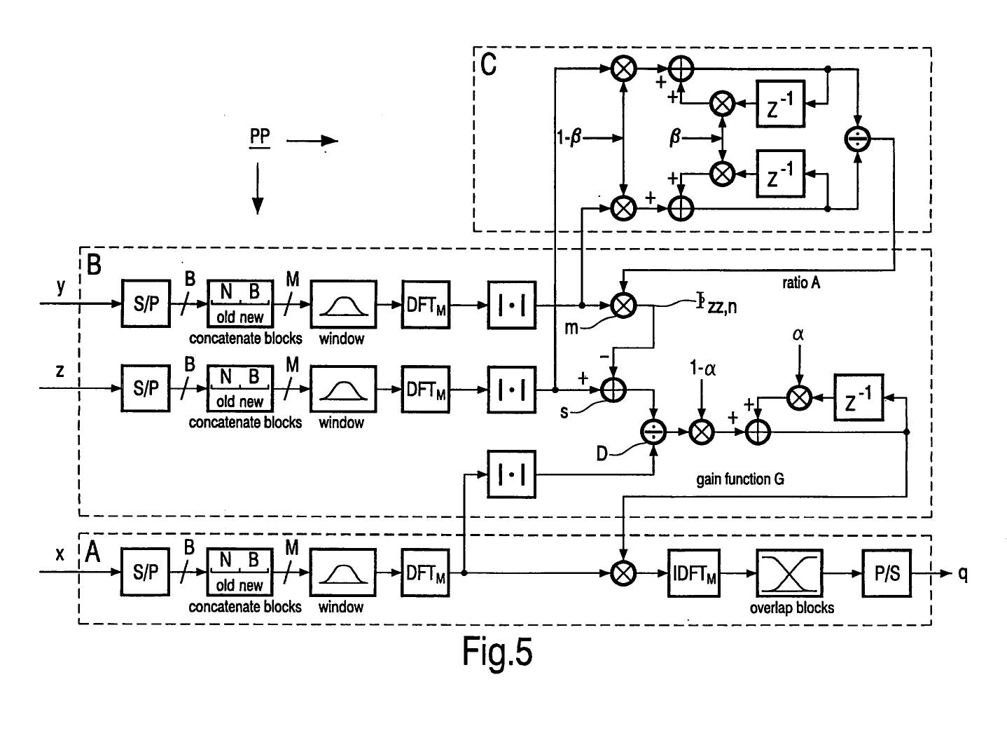

FIG. 5 shows a detailed embodiment of the audio enhancement system of FIG. 1.

FIG. 1 shows a basic diagram of an audio enhancement system 1, embodied by a postprocessor PP, wherein frequency domain signals z, y, r and q are shown. These frequency domain signals are block-wise spectrally computed in the processor PP—schematically denoted A and B in FIG. 5—by means of a Discrete Fourier Transform (FT), for example a Short Time DFT, shortly referred to as STFT. This STFT is a function of both time and frequency, which is expressed by the arguments kB and 1w₀. k denotes the discrete time frame index, B denotes the frame shift, 1 denotes the (discrete) frequency index, and w₀ denotes the elementary frequency spacing. The input signal z indicates a distorted desired signal. It comprises the sum of the desired signal, generally in the form of speech, and distortions, such as noise, echoes, competing speech or reverberation of the desired signal. The signal y indicates a reference signal from which an estimate of the distortion in the distorted desired signal z is to be derived. The signals z and y may originate from one or more microphones 2, as shown in FIGS. 2a, 2b, 3 and 4. In a multi-microphone audio enhancement system 1 there are two or more separate microphones 2, to derive the reference signal from one or more microphones.

The audio enhancement system 1 may comprise adaptive microphone filter means 3 in the case as shown in FIG. 2a, whereas FIG. 2b shows the case wherein the system 1 lacks adaptive filter means. Both cases are combined in FIG. 1 by means of a schematized switch S, which may be open or closed. If the switch S is closed then signal y is subtracted from z to reveal the signal r, which subtraction takes place in a subtracting unit 4 if the filter means 3 are present. If the switch S is open the situation reflects the embodiment of FIG. 2b. Signals z and y and possibly r are fed to the spectral postprocessor PP for spectrally processing the distorted desired signal z or r by means of the reference signal y. The signal q from the postprocessor PP is an output signal which is virtually free of distortion. Its operation will be explained later.

Reference is now made to FIG. 3, which shows an embodiment of the audio enhancement system 1 having several microphones 2. Here the adaptive filter means are embodied by a Generalized Sidelobe Canceller (GSC) 3 coupled to the microphones 2 and the postprocessor PP. In the GSC 3 use is made of a filter and sum beamformer 5-1 denoted by respective transfer functions f₁(w), f₂(w), and f₃(w) to obtain the distorted desired signal z from a linear combination of microphone array signals u₁, u₂, and u₃ respectively. The reference signal y is derived by a blocking matrix B(w) from the respective array signals for projecting these signals into a subspace that is orthogonal to the desired signal. Ideally, output signals x₁ and x₂ of the matrix B(w) do not contain the desired speech but only distortions. A multi-channel adaptive filter 5-2, denoted by w₁(w) and w₂(w) is employed to obtain the reference signal y, after summing, which signal y is then subtracted from the signal z, as explained earlier.

FIG. 4 shows an embodiment of the audio enhancement system 1, here having one microphone 2 and in this case one loudspeaker 6, in addition to having an adaptive echo canceller filter means 7. In a way known per se, the adaptive filter 7 generates an echo replica signal at its output, which is reflected in the reference signal y obtained by adaptively filtering a far end signal in the filter 7. Of course one or more microphones and/or loudspeakers may be included in the possible embodiments of the audio enhancement system 1. The audio enhancement system 1 may be included in a system, in particular a communication system, for example a hands-free communication device, such as a mobile telephone, or a voice controlled system.

The operation of the spectral postprocessor PP will be explained while reference is being made to FIG. 5. Principally the processor PP acts as a controllable gain function for the subsequent frequency bins generated by the Discrete Fourier Transform (DFT) explained above. This gain function is applied to the distorted desired speech signal r, while the phase of the signal r is kept unchanged. Each of these signals are subjected to the following processing steps. After serial to parallel (S/P) conversion a block processing in blocks of size B takes place. Each new block B is appended to the previous block resulting in concatenated blocks. The blocks overlap and are called frames having a size M, which are then windowed and transformed by a DFT of size M, where after for example the magnitude or squared magnitude of the FFT coefficients is taken. Possibly any other positive function of the spectral power may be used.

For a good performance of the audio enhancement the type of gain function and the estimate of the distortion which is present in the input signal here indicated r, are important. Depending on the optimization criterion dealt with various gain functions can be handled. Examples include spectral subtraction, Wiener filtering or for example Minimum Mean-Square Error (MMSE) estimation or log-MMSE estimation based on the spectral amplitude or magnitude, the squared spectral magnitude, the power spectral density or the Mel-scale smoothed spectral density of the signals involved. These techniques may be combined with the applications explained above for audio enhancement systems 1 having one or more microphones and/or loudspeakers.

In the case of a Wiener Filter type the gain function has the form:
G(kB,1w₀)={P_{zz}(kB,1w₀)−P_{zz,n}(kB,1w₀)}/Pₙ(kB,1w₀) (1)
where P_{zz}(kB,1w₀) and Pₙ(kB,1w₀) are measures for the power distribution of signals z and r respectively. If for example the short-time power spectral density (PSD) is taken as a measure for the spectral power distribution then it holds that:
P_{zz}(kB,1w₀)=|z(kB,1w₀)|²
In equation (1) P_{zz,n}(kB,1w₀) is the PSD of the distortion in the signal z, which in general is not known and therefore has to be estimated. An estimate p is proposed therefor reading:
p_{zz,n}(kB,1w₀)=A(kB,1w₀)*P_{yy}(kB,1w₀) (2)
where the ratio term:
A(kB,1w₀)=_{zz}(kB,1w₀)/_{yy}(kB,1w₀}. (3)
Herein is _{zz}(kB,1w₀) the time averaged spectral power of the distortion of the distorted desired signal z—measured during absence of the desired signal, such as speech- and _{yy}(kB,1w₀) is the time averaged spectral power of the reference signal y. As a positive measure for the spectral power for example the spectral amplitude or magnitude, the squared spectral magnitude, the power spectral density or the Mel-scale smoothed spectral density of the signals involved could be taken.

Next the gain function G(kB,1w₀) of equation (1) for the Wiener type filter is implemented in the remainder of block B in FIG. 5, whereas in block C the ratio term A is implemented following equation (3). The spectra in the numerator and denominator of the ratio term A are obtained by smoothing the power spectra in a first order recursion implemented in block C with smoothing constant β. The recursion implementation comprises multipliers X, adders +, delay lines z⁻¹, and a divisor ./. coupled as shown to obtain smoothed PSD versions of the y and z signals. For example the y signal spectrum obeys the smoothing rule:
_{yy}(kB,1w₀)=β_{yy}((k−1)B,1w₀)+(1−β)_{yy}(kB,1w₀)
where the smoothing constant β assumes a value between zero and one, if desired speech is absent in a frame kB, and β=1 else. The same rule applies for the z spectrum. Typically β=0.9 for a frame shift of 16 ms. Any speech detector DET coupled to processor PP can be used to control the value of β. The divisor output reveals the ratio A, as shown.

In a multiplier M in the remainder of the block B the ratio term A is multiplied with the spectrum of Y to implement equation (2), where after the resulting estimate p_{zz,n} is subtracted from the spectrum of the signal z in a subtracter S, where after the result is divided by the spectrum of the signal r in a divisor D to reveal the gain function after being smoothed in a first order smoothing operation. This operation is similar to the smoothing of the signals y and z. A typical smoothing value for α=0.6 for a frame shift of 16 ms. The smoothing operation helps reducing musical tones. After multiplication with the spectrum of the signal r an Inverse DFT is performed, then the blocks are reconstructed and converted from parallel to serial, resulting in the wanted output signal q(kB,1w₀).

Whilst the above has been described with reference to essentially preferred embodiments and best possible modes it will be understood that these embodiments are by no means to be construed as limiting examples of the systems and method concerned, because various modifications, features and combination of features falling within the scope of the appended claims are now within reach of the skilled person.

1. Audio enhancement system (1), comprising audio signal (z, y, r) inputs for a distorted desired signal (z, r) and at least a reference signal (y), and a spectral processor (PP) coupled to the audio signal (z, y, r) inputs for processing the distorted desired signal (z, r) by means of the at least one reference signal (y) acting as an estimate for the distortion of the desired signal (z, r), characterized in that the spectral processor (PP) is arranged for modifying said processing such that the estimate for the distortion is a function of A times the spectral power of the at least one reference signal (y), where A is a ratio between the time averaged spectral power of the distortion of the desired signal and the time averaged spectral power of the at least one reference signal (y).

2. Audio enhancement system (1) according to claim 1, characterized in that the estimate for the distortion is at least partly proportional to A times the spectral power of the al least one reference signal (y).

3. Audio enhancement system (1) according to claim 1, characterized in that the estimate for the distortion at least partly depends on the signal to noise ratio of the distorted desired signal (z, r).

4. Audio enhancement system (1) according to claim 1, characterized in that the respective spectral powers are defined by some positive function of the spectral power concerned, such as the spectral magnitude, the squared spectral magnitude, the power spectral density or the Mel-scale smoothed spectral density.

5. Audio enhancement system (1) according to claim 1, characterized in that the ratio A is calculated based on data acquired during absence of the desired signal.

6. Audio enhancement system (1) according to claim 5, characterized in that the speech enhancement system (1) comprises a speech activity detector (DET), which is coupled to the spectral processor (PP).

7. Audio enhancement system (1) according to claim 1, characterized in that the audio enhancement system (1) comprises adaptive microphone filter means (3) coupled to the spectral processor (PP).

8. Audio enhancement system (1) according to claim 1, characterized in that the audio enhancement system (1) comprises one or more loudspeakers (6) and echo cancelling filter means (7) coupled between the at least one loudspeaker (6) and the spectral processor (PP).

9. System, in particular a communication system, for example a hands-free communication device, such as a mobile telephone, or a voice controlled system, which system is provided with an audio enhancement system (1), the audio enhancement system (1) comprising audio signal (z, r, y) inputs for a distorted desired signal (z, r) and at least a reference signal (y), and a spectral processor (PP) coupled to the audio signal (z, r, y) inputs for processing the distorted desired signal (z, r) by means of the at least one reference signal (y) acting as an estimate for the distortion of the desired signal, characterized in that the spectral processor (PP) is arranged for modifying said processing such that the estimate for the distortion is a function of A times the spectral power of the at least one reference signal (y), where A is a ratio between the time averaged spectral power of the distortion of the desired signal and the time averaged spectral power of the at least one reference signal (y).

10. A method for enhancing a distorted desired signal (z, r), which signal is spectrally processed, whereby at least one reference signal (y) acts as an estimate for the distortion of the desired signal, characterized in that the spectral processing is performed such that the estimate for the distortion depends on A times the spectral power of the at least one reference signal (y), where A is the ratio between the time averaged spectral power of the distortion of the desired signal and the time averaged spectral power of the at least one reference signal (y).
